(19) United States
(12) Patent Application Publication
(10) Pub. No.: US 2011/0306377 A1
(43) Pub. Date: Dec. 15, 2011

(54) RADIO COMMUNICATION SYSTEM, RADIO BASE STATION, RADIO TERMINAL, AND COMMUNICATION CONTROL METHOD

(75) Inventor: Takafumi Shibuya, Kanagawa (JP)

(73) Assignee: KYOCERA CORPORATION, Kyoto (JP)

(21) Appl. No.: 13/203,236

(22) PCT Filed: Feb. 25, 2010
(86) PCT No.: PCT/JP2010/053003

§ 371 Date: Aug. 24, 2011

(30) Foreign Application Priority Data
Feb. 25, 2009 (JP) 2009-043191

(51) Int. Cl. H04W 68/00; H04W 72/08

(52) U.S. Cl. 455/513; 455/517

(57) ABSTRACT

Radio base stations (2B, 2C), to which a radio terminal (1A) is not connected, transmit their respective interference level notifications to the radio terminal (1A). The radio terminal (1A) transmits the received interference level notifications to a radio base station (2A) to which the radio terminal (1A) is connected. The radio base station (2A) appropriately changes, in accordance with the received interference level notifications, the frequency, transmission power and modulation scheme of the uplink communication channel allocated to the radio terminal (1A).

### TECHNICAL FIELD

The present invention relates to: a radio communication system including a radio terminal, a connection-destination radio base station which is a connection destination of the radio terminal, and a non connection-destination radio base station which is not the connection destination of the radio terminal; a radio base station constituting the radio communication system; and a communication control method performed in the connection-destination radio base station.

### BACKGROUND ART

In a radio communication system employing LTE (Long Term Evolution) which is a standard worked out by the 3GPP (Third Generation Partnership Project), a radio base station measures the communication quality of an uplink communication channel allocated to a radio terminal. Based on the communication quality, the radio base station allocates an optimum communication channel to the radio terminal (see Patent Document 1, for example).

The communication channel allocated to the radio terminal by the radio base station, however, suffers interference from a communication channel allocated to a different radio terminal by a different radio base station adjacent thereto. In particular, an interference amount becomes larger, as the radio terminal is located farther from the radio base station and closer to an outer edge of a cell provided by the radio base station. Thus, it is difficult for the radio base station to allocate an optimum communication channel to the radio terminal based on control performed by itself only.

To cope with such a problem, the radio terminal reduces transmission power of the communication channel, when being notified of an interference level from a radio base station (a non connection-destination radio base station) other than the radio base station (connection-destination radio base station) which is a connection destination, in other words, when the communication channel allocated to the radio terminal by the connection-destination radio base station interferes with a communication channel allocated to the different radio terminal by the non connection-destination radio base station.

### PRIOR ART DOCUMENT

### Patent Document

Patent Document 1: Japanese Patent Application Publication No. 2002-247626

### SUMMARY OF THE INVENTION

However, in the aforementioned technique of restraining the interference, the connection-destination radio base station does not know an occurrence of the interference, because the radio terminal independently reduces the transmission power of the communication channel allocated to the radio terminal. For this reason, it cannot be said that the interference is not necessarily restrained appropriately in the whole radio communication system. In addition, if the radio terminal independently performs the control for the interference restraint, the radio terminal bears a large burden.

In view of the above problem, an object of the present invention is to provide a radio communication system, a radio base station, a radio terminal, and a communication control method which are capable of appropriately restraining interference on a communication channel while reducing the burden of the radio terminal.

To solve the above problem, the present invention has following feature. A first feature of the present invention is summarized as a radio communication system (radio communication system 10) including a radio terminal (radio terminal 1A), a connection-destination radio base station (radio base station 2A) which is a connection destination of the radio terminal, and a non connection-destination radio base station (radio base station 2B, 2C) which is not the connection destination of the radio terminal, wherein the non connection-destination radio base station includes a first interference-notification transmitter (interference-level-notification transmission processor 254) configured to transmit an interference notification indicating that uplink communication between the radio terminal and the connection-destination radio base station causes interference, the radio terminal includes a first interference-notification receiver (interference-level-notification reception processor 202) configured to receive the interference notification from the non connection-destination radio base station, and a second interference-notification transmitter (interference-level-notification transmission processor 204) configured to transmit the interference notification received by the first interference-notification receiver, to the connection-destination radio base station, and the connection-destination radio base station includes a second interference-notification receiver (interference-level-notification transmission processor 254) configured to receive the interference notification from the radio terminal, and a communication-channel changing unit (communication-channel changing unit 266) configured to change an uplink communication channel allocated to the radio terminal when the second interference-notification receiver receives the interference notification.

In such a radio communication system, the non connection-destination base station transmits the interference notification to the radio terminal, and the radio terminal transmits the received interference notification to the connection-destination radio base station. In response to the interference notification, the connection-destination radio base station changes the communication channel in an uplink direction allocated to the radio terminal. Accordingly, the connection-destination radio base station can appropriately restrain the interference while knowing that the interference occurs. Moreover, when receiving the interference notification, the radio terminal does not have to independently judge whether or not the change of the communication channel is required but has only to transfer the interference notification, thus bearing a smaller burden.

A second feature of the present invention is summarized as a radio base station which is a connection destination of a radio terminal, the radio base station including: an interference notification receiver configured to receive an interference notification transmitted from a non connection-destination radio base station which is not the connection destination of the radio terminal via the radio terminal, the interface notification indicating that uplink communication between the radio terminal and the radio base station causes interference in the non connection-destination radio base station; and a communication-channel changing unit configured to change an uplink communication channel allocated to the radio terminal when the interference notification receiver receives the interference notification.

A third feature of the present invention according to the second feature is summarized as the communication-channel changing unit changes the uplink communication channel, when the uplink communication with the radio terminal is other than communication requiring real-time processing.

A fourth feature of the present invention according to any one of the second and third features is summarized as the communication-channel changing unit changes the uplink communication channel, when a priority level required for the uplink communication with the radio terminal is lower than a predetermined priority level.

A fifth feature of the present invention according to any one of the second to fourth features is summarized as the communication-channel changing unit changes the uplink communication channel, when the interference notification receiver receives the interference notification for the first time.

A sixth feature of the present invention according to any one of the second to fifth features is summarized as the communication-channel changing unit performs control to decrease transmission power of the uplink communication channel, when no error is occurring in the uplink communication with the radio terminal.

A seventh feature of the present invention according to any one of the second to sixth features is summarized as the communication-channel changing unit performs control to decrease a modulation multi-value number of a modulation method for the uplink communication channel.

An eighth feature of the present invention is summarized as a radio terminal constituting a radio communication system together with a connection-destination radio base station which is a connection destination and a non connection-destination radio base station which is not the connection destination, the radio terminal including: an interference notification receiver configured to receive an interference notification from the non connection-destination radio base station, the interference notification indicating that uplink communication between the radio terminal and the connection-destination radio base station causes interference in the non connection-destination radio base station; and an interference notification transmitter configured to transmit the interference notification received by the interference notification receiver to the connection-destination radio base station.

A ninth feature of the present invention is summarized as a radio base station which is a connection destination of a radio terminal, the method comprising the steps of: receiving, by the radio base station, an interference notification transmitted from a non connection-destination radio base station which is not the connection destination of the radio terminal via the radio terminal, the interference notification indicating that uplink communication between the radio terminal and the radio base station causes interference in the non connection-destination radio base station; and changing, by the radio base station, an uplink communication channel allocated to the radio terminal, when the interference notification is received.

According to the present invention, interference on a communication channel may be retained while reducing the load of the radio terminal.

### BRIEF DESCRIPTION OF THE DRAWINGS

FIG. 1 is an overall schematic configuration diagram of a radio communication system according to an embodiment of the present invention.

FIG. 2 is a schematic configuration diagram of a radio terminal according to the embodiment of the present invention.

FIG. 3 is a functional block configuration diagram of a controller in the radio terminal according to the embodiment of the present invention.

FIG. 4 is a schematic configuration diagram of a radio base station according to the embodiment of the present invention.

FIG. 5 is a first functional block configuration diagram of a controller in the radio base station according to the embodiment of the present invention.

FIG. 6 is a second functional block configuration diagram of the controller in the radio base station according to the embodiment of the present invention.

FIG. 7 is a sequence diagram showing an operation of allocating a communication channel in the radio communication system according to the embodiment of the present invention.

FIG. 8 is a sequence diagram showing an operation of changing the communication channel in the radio communication system according to the embodiment of the present invention.

FIG. 9 is a flowchart showing an operation of a non-connection-destination radio base station in changing the communication channel according to the embodiment of the present invention.

FIG. 10 is a flowchart showing an operation of the radio terminal in changing the communication channel according to the embodiment of the present invention.

FIG. 11 is a first flowchart showing an operation of a connection-destination radio base station in changing the communication channel according to the embodiment of the present invention.

FIG. 12 is a second flowchart showing the operation of the connection-destination radio base station in changing the communication channel according to the embodiment of the present invention

### MODES FOR CARRYING OUT THE INVENTION

Next, a description is given of an embodiment of the present invention by referring to the drawings. Specifically, the description is given of (1) Configuration of Radio Communication System, (2) Operation of Radio Communication System, (3) Advantageous Effects, and (4) Other Embodiment. In the following description of the drawings in the embodiment, same or similar reference signs denote same or similar elements and portions.

### (1) Configuration of Radio Communication System

First, a description is given of a configuration of a radio communication system according to the embodiment of the present invention, in the order of (1.1) Overall Schematic Configuration of Radio Communication System, (1.2) Configuration of Radio Terminal, and (1.3) Configuration of Radio Base Station.

### (1.1) Overall Schematic Configuration of Radio Communication System

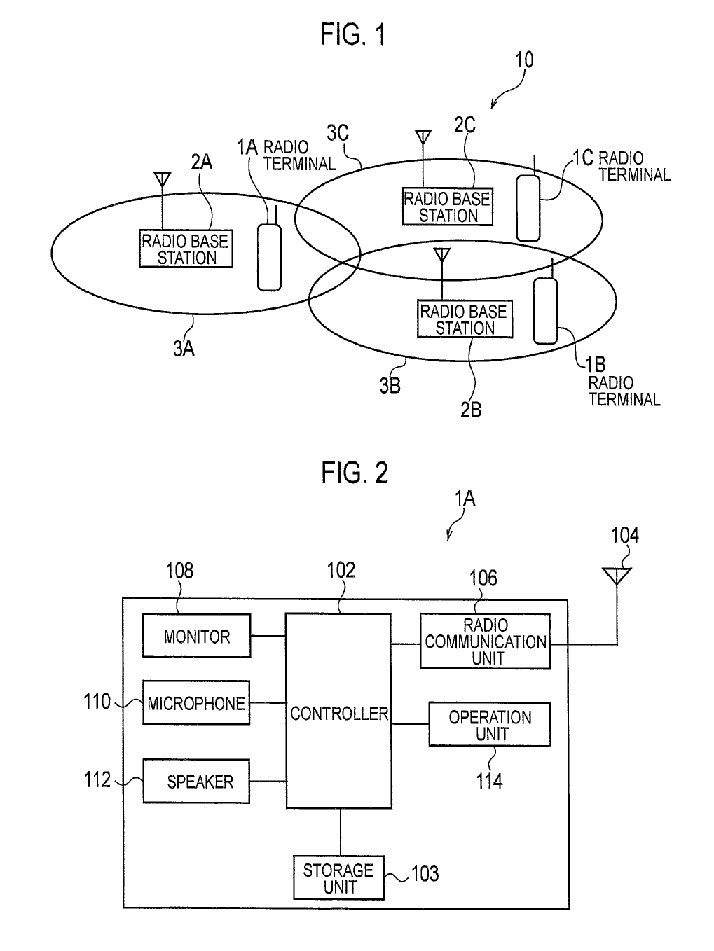

FIG. 1 is an overall schematic configuration diagram of a radio communication system 10 according to the embodiment of the present invention.

As shown in FIG. 1, the radio communication system 10 includes a radio terminal 1A, a radio terminal 1B, a radio terminal 1C, a radio base station 2A, a radio base station 2B, and a radio base station 2C. The radio communication system 10 has a configuration based on LTE which is a standard worked out by the 3GPP. In FIG. 1, the radio terminal 1A visits a cell 3A provided by the radio base station 2A, the radio terminal 1B visits a cell 3B provided by the radio base station 2B, and the radio terminal 1C visits a cell 3C provided by the radio base station 2C.

Each of the radio terminal 1A, the radio terminal 1B, and the radio terminal 1C compares communication qualities (reception SNR, reception RSSI, reception FER, and the like) of reference signals and pilot signals which are transmitted by the radio base stations 2A to 2C, at the time of powering on and handover, and transmits a location registration request to a radio base station which has transmitted a reference signal or the like having the highest quality. Upon receipt of the location registration request from the radio terminal, the radio base station performs the location registration for the radio terminal and allocates communication channels to the radio terminal. This enables communication between the radio terminal and the radio base station.

In the example in FIG. 1, the radio terminal 1A visits the cell 3A. Thus, a reference signal or the like from the radio base station 2A generally has the highest communication quality in the radio terminal 1A. In this case, the radio terminal 1A transmits a location registration request to the radio base station 2A. Upon receipt of the location registration request from the radio terminal 1A, the radio base station 2A performs location registration for the radio terminal 1A and allocates communication channels to the radio terminal 1A.

The radio terminal 1A connects with the radio base station 2A in such processing. This means that the radio base station 2A is a connection-destination radio base station of the radio terminal 1A, and the radio base station 2B and the radio base station 2C are non connection-destination radio base stations of the radio terminal 1A.

Meanwhile, the radio terminal 1B visits the cell 3B. Thus, a reference signal or the like from the radio base station 2B generally has the highest communication quality in the radio terminal 1B. In this case, the radio terminal 1B transmits a location registration request to the radio base station 2B. Upon receipt of the location registration request from the radio terminal 1B, the radio base station 2B performs location registration for the radio terminal 1B and allocates communication channels to the radio terminal 1B.

The radio terminal 1B connects with the radio base station 2B in such processing. This means that the radio base station 2B is a connection-destination radio base station of the radio terminal 1B, and the radio base station 2A and the radio base station 2C are non connection-destination radio base stations of the radio terminal 1B.

In addition, the radio terminal 1C visits the cell 3C. In this case, a reference signal or the like from the radio base station 2C generally has the highest communication quality in the radio terminal 1C. Thus, the radio terminal 1C transmits a location registration request to the radio base station 2C. Upon receipt of the location registration request from the radio terminal 1C, the radio base station 2C performs location registration for the radio terminal 1C and allocates communication channels to the radio terminal 1C.

The radio terminal 1C connects with the radio base station 2C in such processing.

This means that the radio base station 2C is a connection-destination radio base station of the radio terminal 1C, and the radio base station 2A and the radio base station 2B are non connection-destination radio base stations of the radio terminal 1C.

Thereafter, communications are performed between the radio terminal 1A and the radio base station 2A, between the radio terminal 1B and the radio base station 2B, and between the radio terminal 1C and the radio base station 2C. In the example in FIG. 1, the radio terminal 1A transmits data to the radio base station 2A by using an uplink communication channel. In contrast, the radio base station 2A transmits data to the radio terminal 1A by using a downlink communication channel.

Likewise, communications between the radio terminal 1B and the radio base station 2B and communications between the radio terminal 1C and the radio base station 2C are performed.

### (1.2) Configuration of Radio Terminal

Next, a description is given of a configuration of each of the radio terminals 1A to 1C in the order of (1.2.1) Schematic Configuration of Radio Terminal and (1.2.2) Detailed Configuration of Radio Terminal.

However, since schematic configurations of the radio terminal 1B and the radio terminal 1C are the same as the schematic configuration of the radio terminal 1A, descriptions of schematic configurations and detailed configurations of the radio terminal 1B and the radio terminal 1C are omitted.

### (1.2.1) Schematic Configuration of Radio Terminal

FIG. 2 is a schematic configuration diagram of the radio terminal 1A. As shown in FIG. 2, the radio terminal 1A includes a controller 102, a storage unit 103, an antenna 104, a radio communication unit 106, a monitor 108, a microphone 110, a speaker 112, and an operation unit 114.

The controller 102 is formed, for example, by a CPU and controls various functions provided to the radio terminal 1A. The storage unit 103 is formed, for example, by a memory and stores various information used for control and the like performed in the radio terminal 1A.

The radio communication unit 106 includes an RF circuit, a baseband circuit, and the like, performs modulation and demodulation, and encoding and decoding, and the like, and transmits and receives radio signals through the antenna 104. In addition, the radio communication unit 106 periodically receives reference signals and the like transmitted by the radio base stations 2A to 2C, through the antenna 104.

The monitor 108 displays an image received through the controller 102 and displays the detail of operations (such as a telephone number and an address which are inputted). The microphone 110 collects voice and outputs voice data based on the collected voice to the controller 102. The speaker 112 outputs the voice based on the voice data acquired from the controller 102.

The operation unit 114 is formed by ten keys, function keys, and the like and is an interface used for inputting the detail of user operations.

### (1.2.2) Detailed Configuration of Radio Terminal

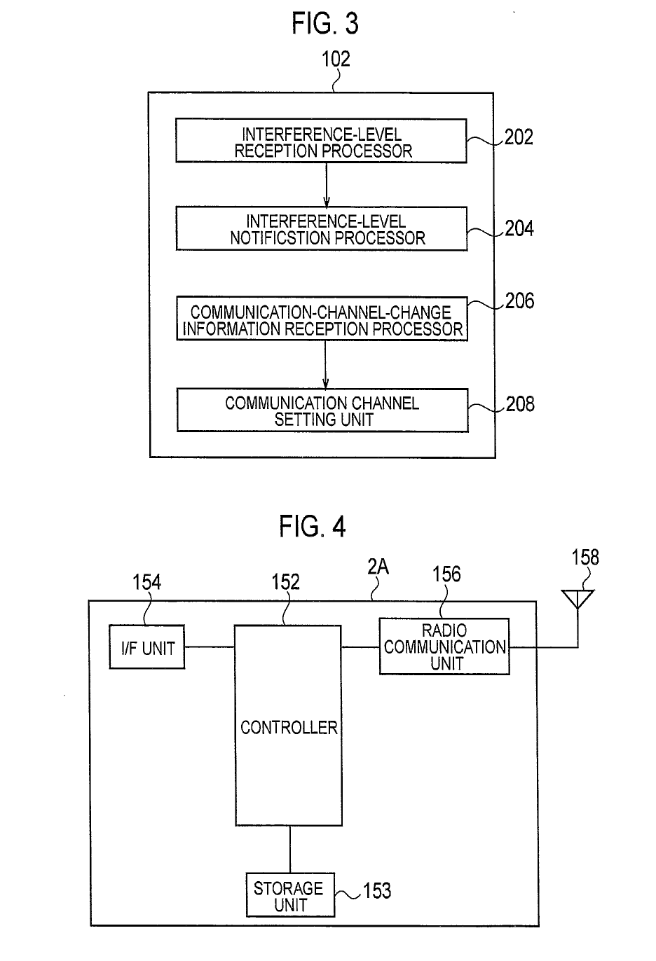

Next, a description is given of the detailed configuration of the radio terminal 1A, specifically, a functional block configuration of the controller 102. FIG. 3 is a functional block configuration diagram of the controller 102. As shown in FIG. 3, the controller 102 includes an interference-level-notification reception processor 202, an interference-level-notification transmission processor 204, a communication-channel-change information reception processor 206, and a communication channel setting unit 208.

When the communication through the uplink communication channel between the radio terminal 1A and the radio base station 2A (communication channel from the radio terminal 1A to the radio base station 2A) causes interference in the communication channel of the radio base station 2B (communication channel between the radio base station 2B and the radio terminal 1B) or the communication channel of the radio base station 2C (communication channel between the radio base station 2C and the radio terminal 1C) and when the level thereof is equal to or higher than a predetermined value, the radio base station 2B or the radio base station 2C transmits an interference level notification for the radio terminal 1A, the interference level notification including the level of the interference.

The interference-level-notification reception processor 202 receives the interference level notification from the radio base station 2B or the radio base station 2C which is the non connection-destination radio base station of the radio terminal 1A. Further, the interference-level-notification reception processor 202 outputs the received interference level notification to the interference-level-notification transmission processor 204.

The interference-level-notification transmission processor 204 transmits the interference level notification to the radio base station 2A which is the connection-destination radio base station by using a control channel in the uplink direction (uplink control channel).

The communication-channel-change information reception processor 206 receives communication channel change information (to be described later) from the radio base station 2A which is the connection-destination radio base station. The communication channel change information includes the frequency, transmission power, and a modulation method of the changed uplink communication channel, as appropriate.

The communication channel setting unit 208 sets the uplink communication channel on the basis of the frequency, the transmission power, and the modulation method of the changed uplink communication channel included in the communication channel change information. Thereafter, the radio terminal 1A transmits a radio signal to the radio base station 2A by using the set uplink communication channel.

### (1.3) Configuration of Radio Base Station

Next, a description is given of the configuration of each of the radio base stations 2A to 1C in the order of (1.3.1) Schematic Configuration of Radio Base Station and (1.3.2) Detailed Configuration of Radio Base Station. However, since the schematic configurations of the radio base station 2B and the radio base station 2C are the same as the schematic configuration of the radio base station 2A, descriptions of the schematic configurations of the radio base station 2B and the radio base station 2C are omitted.

### (1.3.1) Schematic Configuration of Radio Base Station

FIG. 4 is a schematic configuration diagram of the radio base station 2A. As shown in FIG. 4, the radio base station 2A includes a controller 152, a storage unit 153, an I/F unit 154, a radio communication unit 156, and an antenna 158.

The controller 152 is formed, for example, by a CPU and controls various functions provided to the radio base station 2A. The storage unit 153 is formed, for example, by a memory and stores various information used for control and the like performed in the radio base station 2A.

The I/F unit 154 is connected to an access gateway or the like existing in a network, through a router or the like.

The radio communication unit 156 includes an RF circuit, a baseband circuit, and the like, performs modulation and demodulation, and encoding and decoding, and the like, and transmits and receives radio signals through the antenna 158. In addition, the radio communication unit 156 transmits reference signals and the like through the antenna 158.

### (1.3.2) Detailed Configuration of Radio Base Station

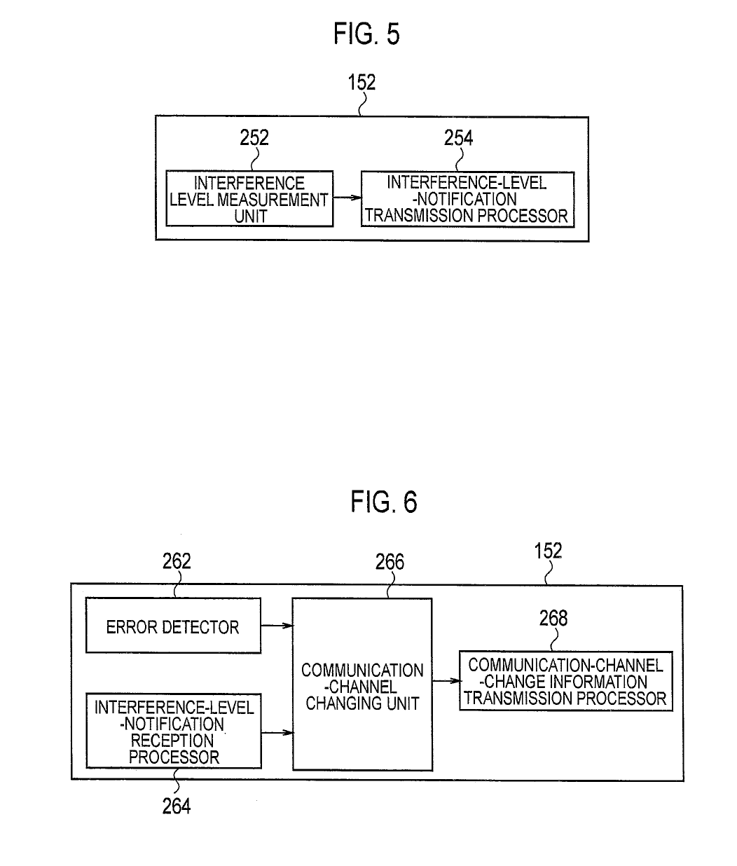

Next, a description is given of the detailed configuration of the radio base stations 2A to 1C, specifically a functional block configuration of the controller 152. FIG. 5 is a functional block configuration diagram of the controller 152 of the radio base station 2A in the case where the radio base station 2A is the non connection-destination radio base station of the radio terminal 1B or the radio terminal 1C.

Note that the controller 152 of the radio base station 2B in the case where the radio base station 2B is the non connection-destination radio base station of the radio terminal 1A or the radio terminal 1C and the controller 152 of the radio base station 2C in the case where the radio base station 2C is the non connection-destination radio base station of the radio terminal 1A or the radio terminal 1B are the same as the controller 152 of the radio base station 2A, and thus a description thereof will be omitted.

As shown in FIG. 5, the controller 152 includes an interference level measurement unit 252 and an interference-level-notification transmission processor 254.

The interference level measurement unit 252 measures the level (CQI, for example) of the interference occurring in the communication channel between the radio terminal 1A and the radio base station 2A due to the communication through the uplink communication channel between the radio terminal 1B and the radio base station 2B. Further, when the interference level is equal to or higher than the predetermined value, the interference level measurement unit 252 outputs the interference level to the interference-level-notification transmission processor 254.

The interference-level-notification transmission processor 254 transmits the interference level notification including the interference level from the interference level measurement unit 252 to the radio terminal 1B or the radio terminal 1C.

Note that also when interference occurs in the communication channel between the radio terminal 1A and the radio base station 2A due to the communication through the uplink communication channel between the radio terminal 1C (radio terminal 1B) and the radio base station 2C (radio base station 2B), the interference level measurement unit 252 and the interference-level-notification transmission processor 254 performs the same processing as described above.

FIG. 6 is a functional block configuration diagram of the controller 152 of the radio base station 2A in the case where the radio base station 2A is the connection-destination radio base station of the radio terminal 1A. Note that the controller 152 of the radio base station 2B in the case where the radio base station 2B is the connection-destination radio base station of the radio terminal 1B and the controller 152 of the radio base station 2B in the case where the radio base station 2C is the connection-destination radio base station of the radio terminal 1C are the same as the controller 152 of the radio base station 2A, and thus descriptions thereof are omitted.

As shown in FIG. 5, the controller 152 includes an error detector 262, an interference-level-notification reception processor 264, a communication-channel changing unit 266, and a communication-channel-change information transmission processor 268.

The error detector 262 receives data obtained by demodulating and decoding the radio signal transmitted from the radio terminal 1A through the uplink communication channel. Further, the error detector 266 detects an error of the received data. For example, the error detector 262 performs error detection based on CRC data included in the received data. Further, the error detector 262 outputs the data and a result of the error detection to the communication-channel changing unit 266.

The interference-level-notification reception processor 264 receives an interference level notification obtained by demodulating and decoding the radio signal transmitted from the radio terminal 1A through the uplink control channel. Further, the interference-level-notification reception processor 264 outputs the interference level notification to the communication-channel changing unit 266.

Based on the error detection result from the error detector 262 and the interference level notification from the interference-level-notification reception processor 264, the communication-channel changing unit 266 changes the uplink communication channel allocated to the radio terminal 1A.

Specifically, the communication-channel changing unit 266 judges whether or not the interference level notification from the radio terminal 1A is received for the first time. The interference level notification includes an ID of a radio terminal which is a transmission source. The communication-channel changing unit 266 can know the number of times of notifications of the interference level from the radio terminal by extracting and recognizing the radio terminal ID included in the interference level notification.

In addition, the communication-channel changing unit 266 judges whether or not the communication in the uplink direction (uplink communication) with the radio terminal 1A is any one of communication requiring real-time processing and high-priority communication. For example, data transferred in the uplink communication includes required QoS and attribute information indicating that the data is data of voice, image, or the like which requires real-time processing. Based on the attribute information included in the data, the communication-channel changing unit 266 can judge whether or not the uplink communication with the radio terminal 1A is the communication requiring the real-time processing. The communication-channel changing unit 266 can also judge that the uplink communication is the high-priority communication when QoS included in the data is equal to or higher than a predetermined value.

In addition, the radio channel changing unit 266 judges whether or not an error is occurring in the uplink communication with the radio terminal 1A, based on the error detection result.

Based on the judgment result described above, the radio channel changing unit 266 performs the frequency change, the transmission power change, and the modulation method change, as appropriate, on the uplink communication channel allocated to the radio terminal 1A. Further, the communication-channel changing unit 266 outputs the communication channel change information including the changed frequency, transmission power, and modulation method, as appropriate, to the communication-channel-change information transmission processor 268.

The communication-channel-change information transmission processor 268 transmits the communication channel change information to the radio terminal 1A which is a transmission source of the interference level notification.

### (2) Operation of Radio Communication System

Next, a description is given of an operation of the radio communication system 10. The description is given below by taking as an example the case where the radio base station 2A is the connection-destination radio base station of the radio terminal 1A and the radio base station 2B and the radio base station 2C are the non connection-destination radio base stations.

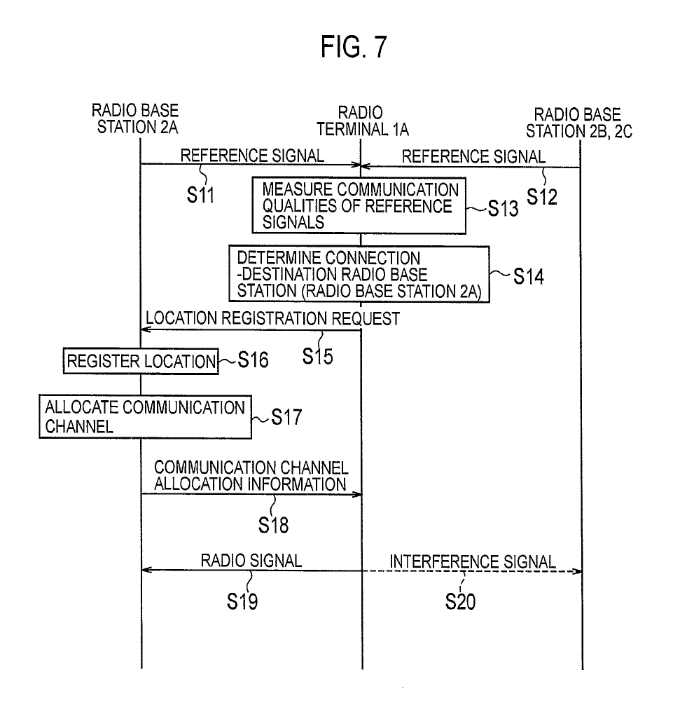

FIG. 7 is a sequence diagram showing an operation at the time when the radio terminal 1A connects with the radio base station 2A in the radio communication system 10.

In Step S11, the radio base station 2A transmits a reference signal. The radio terminal 1A receives the reference signal from the radio base station 2A at the time of powering on and handover. Likewise, in Step S12, the radio base stations 2B and 2C transmit reference signals, respectively. The radio terminal 1A receives the reference signals from the radio base stations 2B and 2C at the time of powering on and handover.

In Step S13, the radio terminal 1A measures communication qualities of the received reference signals. In Step S14, the radio terminal 1A determines, as a connection-destination radio base station, one of the radio base stations which has transmitted a reference signal having the highest communication quality. Here, the radio base station 2A is the connection-destination radio base station of the radio terminal 1A.

In Step S15, the radio terminal 1A transmits a location registration request to the radio base station 2A which is the connection-destination radio base station. The radio base station 2A receives the location registration request from the radio terminal 1A. In Step S16, the radio base station 2A performs location registration for the radio terminal 1A.

In Step S17, the radio base station 2A allocates communication channels (an uplink communication channel and a downlink communication channel) to the radio terminal 1A. In Step S18, the radio base station 2A further transmits, to the radio terminal 1A, communication channel allocation information including identification information, and the like, on the allocated communication channels. The radio terminal 1A receives the communication channel allocation information from the radio base station 2A.

In Step S19, the radio terminal 1A transmits a radio signal to the radio base station 2A by using the uplink communication channel allocated thereto. The radio base station 2A receives the radio signal from the radio terminal 1A.

In addition, as shown in Step S20, the radio signal transmitted by the radio terminal 1A might be an interference signal of the communication channels of the radio base stations 2B and 2C.

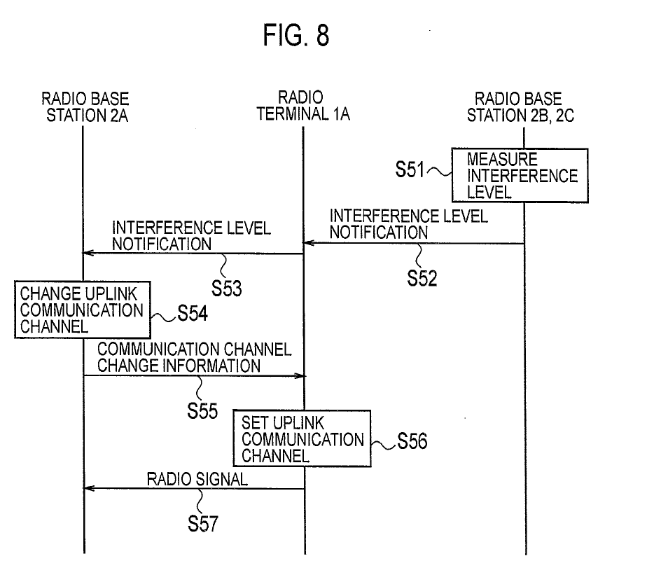

FIG. 8 is a sequence diagram showing an operation of changing the communication channel in the radio communication system 10.

In Step S51, the radio base station 2B which is the non connection-destination radio base station of the radio terminal 1A measures the level of interference occurring in the communication channel of the radio base station 2B due to the communication through the uplink communication channel between the radio terminal 1A and the radio base station 2A. Likewise, the radio base station 2C which is the non connection-destination radio base station of the radio terminal 1A measures the level of interference occurring in the communication channel of the radio base station 2C due to the communication through the uplink communication channel between the radio terminal 1A and the radio base station 2A.

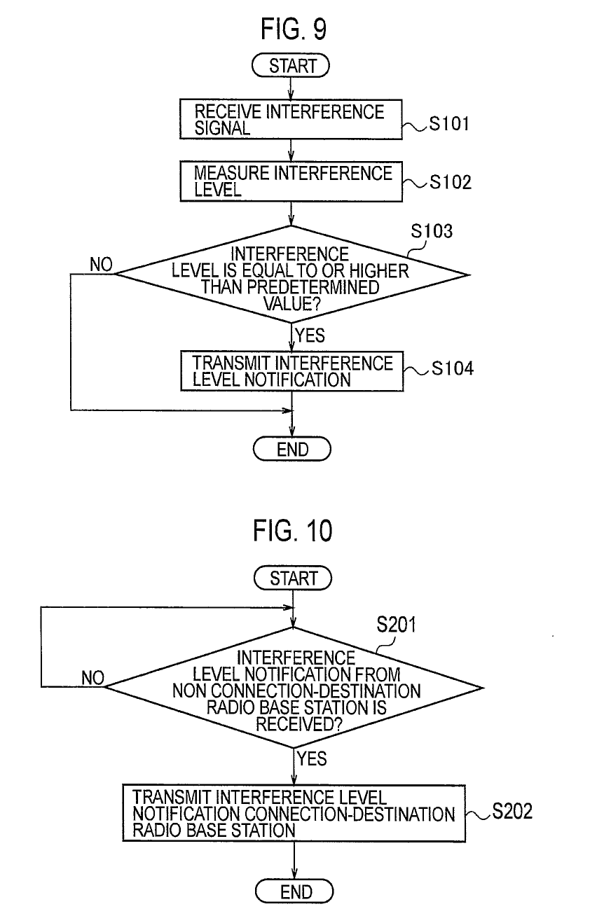

FIG. 9 is a flowchart showing an operation of changing the communication channel performed in the radio base station 2B or 2C which is the non connection-destination radio base station.

When the radio base station 2B or 2C receives the interference signal in Step S101, the controller 152 in the radio base station 2B or 2C measures the level of the interference signal (interference level) in Step S102.

In Step S103, the controller 152 judges whether or not the measured interference level is equal to or higher than the predetermined value. If the interference level is equal to or higher than the predetermined value, in Step S104 the controller 152 transmits the interference level notification including the interference level to the radio terminal 1A by using the uplink control channel.

The description is continued by referring back again to FIG. 8. In Step S52 and Step S53, the interference level notification from the radio base station 2B or 2C is transmitted to the radio base station 2A via the radio terminal 1A.

FIG. 10 is a flowchart showing an operation of the radio terminal 1A in changing the communication channel.

In Step S201, the controller 102 in the radio terminal 1A judges whether or not an interference level notification from at least any one of the radio base station 2B and the radio base station 2C which are non connection-destination radio base stations is received.

If the interference level notification is received, in Step S202 the controller 102 transmits the interference level notification to the radio base station 2A which is the connection-destination radio base station.

The description is continued by referring back again to FIG. 8. In Step S54, the radio base station 2A performs processing of changing the uplink communication channel allocated to the radio terminal 1A.

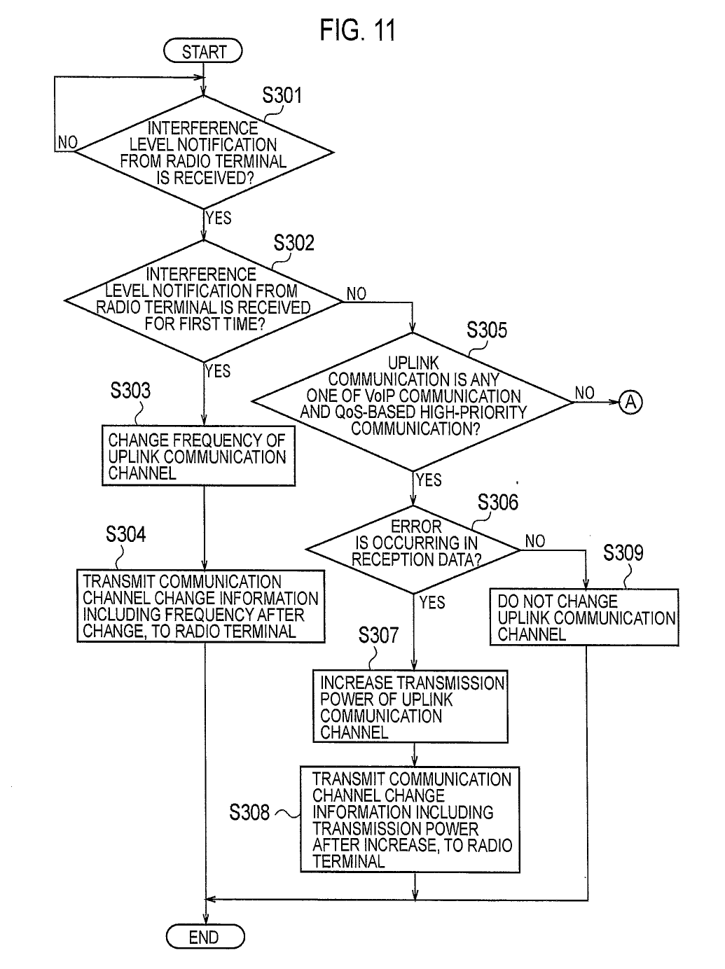

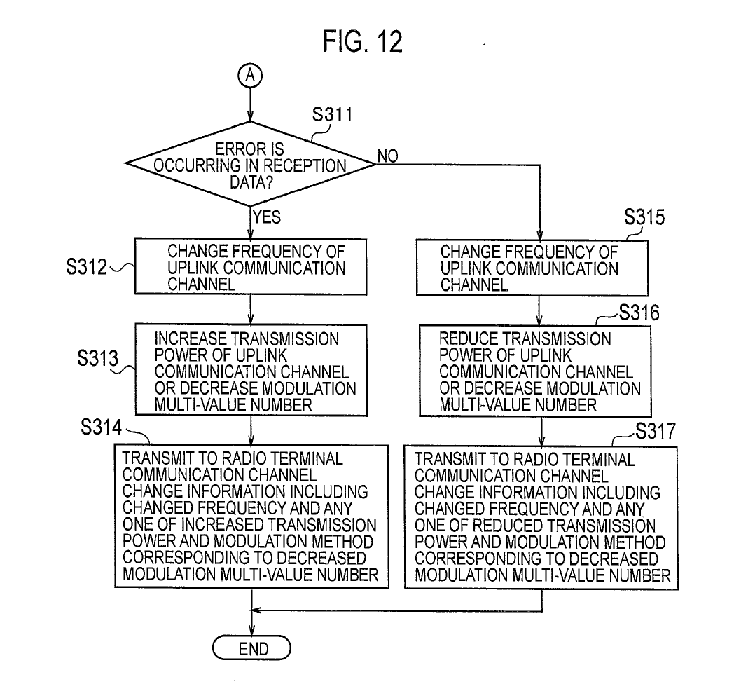

FIG. 11 and FIG. 12 are flowcharts showing an operation of the radio base station 2A in changing the communication channel, the radio base station 2A being the connection-destination radio base station.

In Step S301, the controller 152 in the radio base station 2A judges whether or not the interference level notification from the radio terminal 1A is received. If the interference level notification from the radio terminal 1A is received, in Step S302 the controller 152 judges whether or not the interference level notification from the radio terminal 1A is received for the first time.

If the interference level notification from the radio terminal 1A is received for the first time, the controller 152 changes the frequency of the uplink communication channel allocated to the radio terminal 1A so as to restrain interference occurring in the communication channel of at least any one of the radio base station 2B and the radio base station 2C. Further, in Step S304, the controller 152 transmits communication channel change information including the frequency after the change, to the radio terminal 1A.

On the other hand, if it is judged in Step S302 that the interference level notification from the radio terminal 1A is not received for the first time, in Step S305 the controller 152 judges whether or not the uplink communication with the radio terminal 1A is any one of a VoIP communication requiring the real-time processing and the QoS-based high-priority communication.

If the uplink communication with the radio terminal 1A is any one of the VoIP communication requiring the real-time processing and the QoS-based high-priority communication, in Step S306 the controller 152 judges whether or not an error is occurring in data (reception data) obtained from the radio signal transmitted by using the uplink communication channel from the radio terminal 1A.

If an error is occurring in the reception data, the error needs to be restrained. Thus, in Step S307, the controller 152 increases the transmission power of the uplink communication channel allocated to the radio terminal 1A. Further, in Step S308, the controller 152 transmits the communication channel change information including the transmission power after the increase, to the radio terminal 1A.

On the other hand, if it is judged in Step S306 that an error does not occur in the reception data, in Step S309 the controller 152 does not change but maintains the uplink communication channel allocated to the radio terminal 1A so as to maintain the communication with the radio terminal 1A in a high communication quality.

In addition, if it is judged in step S305 that the uplink communication with the radio terminal 1A is not any one of the VoIP communication requiring the real-time processing and the QoS-based high-priority communication, the processing proceeds to the operation shown in FIG. 12. In Step S311, the controller 152 judges whether or not an error is occurring in the reception data.

If an error is occurring in the reception data, in Step S312 the controller 152 changes the frequency of the uplink communication channel allocated to the radio terminal 1A so as to restrain interference occurring in the communication channel of the radio base station 2B or the radio base station 2C.

Further, in Step S313, the controller 152 increases the transmission power of the uplink communication channel allocated to the radio terminal 1A so as to restrain the error in the reception data. Alternatively, the controller 152 decreases a modulation multi-value number of the modulation method for the uplink communication channel allocated to the radio terminal 1A.

Further, in Step S314, the controller 152 transmits, to the radio terminal 1A, the communication channel change information including the changed frequency and any one of the increased transmission power and the modulation method corresponding to the decreased modulation multi-value number.

On the other hand, if it is judged in Step S311 that an error does not occur in the reception data, in Step S315 the controller 152 changes the frequency of the uplink communication channel allocated to the radio terminal 1A so as to restrain the interference occurring in the communication channel in the radio base station 2B or the radio base station 2C.

Further, in step S316, the controller 152 reduces the transmission power of the uplink communication channel allocated to the radio terminal 1A. Alternatively, the controller 152 decreases the modulation multi-value number of the modulation method for the uplink communication channel allocated to the radio terminal 1A.

Further, in step S317, the controller 152 transmits, to the radio terminal 1A, the communication channel change information including the changed frequency and any one of the reduced transmission power and the modulation method corresponding to the decreased modulation multi-value number.

The description is continued by referring back again to FIG. 8. In Step S55, the radio terminal 1A receives the communication channel change information from the radio base station 2A. Further, in Step S56, the radio terminal 1A sets the uplink communication channel based on the frequency, the transmission power, and the modulation method of the uplink communication channel which are changed and are included in the communication channel change information. Thereafter, in Step S57, the radio terminal 1A transmits the radio signal to the radio base station 2A by using the set uplink communication channel.

### (3) Advantageous Effects

As described above, with the radio communication system 10 according to the embodiment of the present invention, the radio base station 2B or the radio base station 2C which is the non connection-destination base station of the radio terminal 1A transmits the interference level notification for the radio terminal 1A. The radio terminal 1A transmits the received interference level notification to the radio base station 2A which is the connection-destination radio base station. In response to the interference level notification, the radio base station 2A then changes the frequency, the transmission power, and the modulation method of the communication channel in the uplink direction allocated to the radio terminal 1A, as appropriate.

Accordingly, the radio base station 2A can appropriately restrain the interference while knowing that the interference occurs on the communication channel in the radio base station 2B or the radio base station 2C. In addition, when receiving the interference level notification, the radio terminal 1A does not have to independently determine whether or not the change of the uplink communication channel is required and has only to transfer the interference level notification, thus bearing a smaller load.

Moreover, when the uplink communication between the radio terminal 1A and the radio base station 2A is communication requiring the real-time processing or high-priority communication, deterioration of the communication quality due to the change of the uplink communication channel needs to be prevented.

Thus, when the uplink communication with the radio terminal 1A is the communication requiring the real-time processing or the high-priority communication and when an error has not occurred in the reception data from the radio terminal 1A, the radio base station 2A does not change the uplink communication channel allocated to the radio terminal 1A. This enables appropriate control performed in consideration of maintaining the communication quality of the uplink communication between the radio terminal 1A and the radio base station 2A.

In contrast, when the uplink communication with the radio terminal 1A is the communication requiring the real-time processing or the high-priority communication and when an error has occurred in the reception data from the radio terminal 1A, the radio base station 2A increases the transmission power of the uplink communication channel allocated to the radio terminal 1A. This enables appropriate control from a view point of priority given to improvement of the quality of the uplink communication with the radio terminal 1A over the interference restraint in the communication channel of the radio base station 2B or the radio base station 2C.

### (4) Alternative Embodiments

As described above, the present invention has been described by using the embodiment. However, it should not be understood that the description and drawings which constitute part of this disclosure limit the present invention. From this disclosure, various alternative embodiments, examples, and operation techniques will be easily found by those skilled in the art.

In the aforementioned embodiment, the radio base station 2A which is the connection-destination radio base station of the radio terminal 1A changes the frequency, the transmission power, and the modulation multi-value number of the modulation method for the uplink communication channel. These elements can be combined with each other as appropriate to change the uplink communication channel.

Meanwhile, the description has been given of the radio communication system employing LTE in the aforementioned embodiment. However, the present invention is applicable to any radio communication system as long as communication using an uplink communication channel between a radio terminal and a radio base station is performed therein.

As described above, it should be understood that the present invention includes various embodiments which are not described herein. Accordingly, the technical scope of the present invention should be determined only by the matters to define the invention in the scope of claims regarded as appropriate based on the disclosure.

Note that the entire content of Japanese Patent Application No. 2009-043191 (filed on Feb. 25, 2009) is incorporated herein by reference.

### INDUSTRIAL APPLICABILITY

A radio communication system, a radio base station, a radio terminal, and a communication control method are capable of appropriately restraining interference on a communication channel while reducing the load of the radio terminal, and useful for the communication system.

1. A radio communication system comprising a radio terminal, a connection-destination radio base station which is a connection destination of the radio terminal, and a non connection-destination radio base station which is not the connection destination of the radio terminal, wherein
the non connection-destination radio base station comprises
a first interference-notification transmitter configured to transmit an interference notification indicating that uplink communication between the radio terminal and the connection-destination radio base station causes interference,
the radio terminal comprises
a first interference-notification receiver configured to receive the interference notification from the non connection-destination radio base station, and
a second interference-notification transmitter configured to transmit the interference notification received by the first interference-notification receiver, to the connection-destination radio base station, and
the connection-destination radio base station comprises
a second interference-notification receiver configured to receive the interference notification from the radio terminal, and
a communication-channel changing unit configured to change an uplink communication channel allocated to the radio terminal when the second interference-notification receiver receives the interference notification.

2. A radio base station which is a connection destination of a radio terminal, the radio base station comprising:
an interference notification receiver configured to receive an interference notification transmitted from a non connection-destination radio base station which is not the connection destination of the radio terminal via the radio terminal, the interface notification indicating that uplink communication between the radio terminal and the radio base station causes interference in the non connection-destination radio base station; and
a communication-channel changing unit configured to change an uplink communication channel allocated to the radio terminal when the interference notification receiver receives the interference notification.

3. The radio base station according to claim 2, wherein the communication-channel changing unit changes the uplink communication channel, when the uplink communication with the radio terminal is other than communication requiring real-time processing.

4. The radio base station according to claim 2, wherein the communication-channel changing unit changes the uplink communication channel, when a priority level required for the uplink communication with the radio terminal is lower than a predetermined priority level.

5. The radio base station according to claim 2, wherein the communication-channel changing unit changes the uplink communication channel, when the interference notification receiver receives the interference notification for the first time.

6. The radio base station according to claim 3, wherein the communication-channel changing unit performs control to decrease transmission power of the uplink communication channel, when no error is occurring in the uplink communication with the radio terminal.

7. The radio base station according to claim 3, wherein the communication-channel changing unit performs control to decrease a modulation multi-value number of a modulation method for the uplink communication channel.

8. A radio terminal constituting a radio communication system together with a connection-destination radio base station which is a connection destination and a non connection-destination radio base station which is not the connection destination, the radio terminal comprising:
an interference notification receiver configured to receive an interference notification from the non connection-destination radio base station, the interference notification indicating that uplink communication between the radio terminal and the connection-destination radio base station causes interference in the non connection-destination radio base station; and
an interference notification transmitter configured to transmit the interference notification received by the interference notification receiver to the connection-destination radio base station.

9. A communication control method performed in a radio base station which is a connection destination of a radio terminal, the method comprising the steps of:
receiving, by the radio base station, an interference notification transmitted from a non connection-destination radio base station which is not the connection destination of the radio terminal via the radio terminal, the interference notification indicating that uplink communication between the radio terminal and the radio base station causes interference in the non connection-destination radio base station; and
changing, by the radio base station, an uplink communication channel allocated to the radio terminal, when the interference notification is received.
